(19) United States
(12) Patent Application Publication
(10) Pub. No.: US 2014/0211684 A1
(43) Pub. Date: Jul. 31, 2014

(54) METHOD AND SYSTEM FOR CHANNEL FEEDBACK IN WIRELESS COMMUNICATIONS

(71) Applicants: Hao Liu, Shanghai (CN); Hongwei Yang, Shanghai (CN); Lu Wu, Shanghai (CN)

(72) Inventors: Hao Liu, Shanghai (CN); Hongwei Yang, Shanghai (CN); Lu Wu, Shanghai (CN)

(73) Assignee: ALCATEL LUCENT, Paris (FR)

(21) Appl. No.: 14/239,437

(22) PCT Filed: Aug. 14, 2012
(86) PCT No.: PCT/IB2012/001893

§ 371 Date: Feb. 18, 2014

(30) Foreign Application Priority Data
Aug. 16, 2011 (CN) 201110235015.2

(51) Int. Cl. H04W 72/00

(52) U.S. Cl. CPC H04W 72/005
USPC 370/312

(57) ABSTRACT

Embodiments of the present invention generally relate to a method and system of channel feedback in wireless communications. Specifically, according to embodiments of the present invention, there is provided a two-stage Co MP feedback mechanism, such that different types of channel feedback are transmitted in each stage. Specifically, during the first stage, information regarding long-term features and/or wideband features of a channel is fed back; while during the second stage, information regarding short-term features and/or narrow features of channel is fed back. The first stage and the second stage may be periodically repeated. The information fed back during the first and second stages are used to calculate feedback information characterizing a joint-channel feature. In this way, overheads associated with channel feedback may be effectively reduced. Corresponding methods and apparatuses are also disclosed.

### PRIORITY

The present application claims a priority right of the Chinese invention patent application No. 201110235015.2 filed on Aug. 16, 2011.

### TECHNICAL FIELD

Embodiments of the present invention generally relate to the field of wireless communications, and more specifically, to a method and system of channel feedback in wireless communications.

### BACKGROUND

The long-term evolution (LTE)/advanced long-term evolution (LTE-A) criterion and system of the 3^{rd} Generation Partnership Project (3GPP) are regarded as significant development orientations of a wireless communication system. In such wireless communication system, a user equipment (UE) at cell edge is always interfered with due to relatively weak signals by signals from other cells, which results in relatively poor signal quality. In order to satisfy LTE-A's demands on aspects such as system capacity, transient peak data rate, frequency spectrum, cell edge user throughput, and time delay, etc., a Coordinated Multi-Point (CoMP) has been proposed currently to enhance system performance.

In the LTE/LTE-A system, the CoMP transmission may be effectively used to reduce inter-cell interference, enhance date rate coverage area, cell edge throughput and/or improve the overall throughput of the system. It is known that the CoMP transmission (particularly CoMP joint transmission) requires massive channel information feedback information from each UE so as to perform centralized scheduling and centralized pre-coding between all coordinated base stations (also called eNodeB or eNB in 3GPP).

Serious resource overheads will be caused by massive channel feedback information provided by a plurality of UEs to a base station. Therefore, a concatenated codebook feedback for CoMP channel feedback has been proposed. Such feedback mechanism has a flexible codebook size design and is also suitable for any kind of antenna arrangement and cell location. However, by far, various kinds of feedback mechanisms for CoMP in the prior art are only a single-stage feedback. Specifically, a cell-specific feedback and inter-cell phase/amplitude adjustment has the same feedback time period and feedback granularity. In other words, different types of feedback information are transmitted from the UEs to the base station with the same feedback period at the same transmission time.

However, those skilled in the art would appreciate that different features of a channel present different natures in terms of varying period and the like. For example, some long-term channel features (for example, cell-specific channel features) usually maintain relative stably within a relatively long period of time; in contrast, some short-term channel features (for example, channel features related to inter-cell coordination) vary relatively frequently. It would cause unnecessary resource wastes to return measurement feedbacks for different types of channel features from the UEs to the base station at the same feedback period and granularity, which causes extra feedback overheads.

Therefore, a solution is desirable in the related art capable of further reducing the channel feedback overheads in a wireless communication system using CoMP, thereby improving overall performance of the system.

### SUMMARY

In order to solve the above problems currently existing in the related art, embodiments of the present invention provide a method and system of channel feedback in wireless communications.

The inventive idea of the present invention primarily lies in dividing channel feedback from a UE to a base station into two stages in a wireless communication system using CoMP transmission, while transmitting different types of channel feedback at each stage. More specifically, during the first stage (which is also called the first period of time), information on long-term feature and/or wideband feature of the channel is fed back; during the second stage (which is also called the second period of time), information on short-term feature and/or subband feature of the channel is fed back. The first stage and the second stage may be repeated periodically, and optionally, their cycles may be either equal or different. The information fed back at the first stage and the second stage is used at the base station for deriving overall feedback information characterizing a joint-channel feature. In this way, overheads associated with channel feedback can be effectively reduced.

According to a first aspect of the present invention, there is provided a method of providing channel feedback from a user equipment in a wireless communication system using coordinated multi-point (CoMP) joint transmission. The method comprising: during a first period of time, transmitting a first group of channel feedback to a base station in the wireless communication system; and during a second period of time, transmitting to the base station a second group of channel feedback of a different type from the first group of channel feedback.

According to a second aspect of the present invention, there is provided a method of obtaining channel feedback at a base station in a wireless communication system using coordinated multi-point (CoMP) joint transmission. The method comprises: during a first period of time, receiving a first group of channel feedback from a user equipment in the wireless communication system; during a second period of time, receiving from the user equipment a second group of channel feedback of a different type from the first group of channel feedback; and generating feedback information characterizing channel conditions between the base station and the user equipment based on the first group of channel feedback and the second group of channel feedback.

According to a third aspect of the present invention, there is provided an apparatus for providing feedback channel from a user equipment in a wireless communication system using coordinated multi-point (CoMP) joint transmission. The apparatus comprises: first feedback transmitting means configured to transmit a first group of channel feedback to a base station in the wireless communication system during a first period of time; and second feedback transmitting means configured to transmit a second group of channel feedback of a different type from the first group of channel feedback to the base station during a second period of time.

According to a fourth aspect of the present invention, there is provided an apparatus for obtaining channel feedback at a base station in a wireless communication system using coordinated multi-point (CoMP) joint transmission. The apparatus comprises: first feedback receiving means configured to receive a first group of channel feedback from a user equipment in the wireless communication system during a first period of time; second feedback receiving means configured to receive a second group of channel feedback of a different type from the first group of channel feedback from the user equipment during a second period of time; and feedback information generating means configured to generate feedback information characterizing channel conditions between the base station and the user equipment based on the first group of channel feedback and the second group of channel feedback.

### BRIEF DESCRIPTION OF THE DRAWINGS

The above and other objectives, features, and advantages of embodiments of the present invention will become more comprehensible through reading the following detailed description with reference to the accompanying drawings. In the drawings, several feasible embodiments of the present invention are illustrated in an exemplary, but non-limiting, manner, wherein

FIG. 1 shows a flowchart of a method 100 of providing channel feedback from a user equipment in a wireless communication system using coordinated multi-point CoMP joint transmission according to exemplary embodiments of the present invention;

FIG. 2 shows a flowchart of a method 200 of obtaining channel feedback at a base station in a wireless communication system using coordinated multi-point CoMP joint transmission according to exemplary embodiments of the present invention;

FIG. 3 shows a block diagram of an apparatus 300 for providing feedback channel from a user equipment in a wireless communication system using coordinated multi-point CoMP joint transmission according to exemplary embodiments of the present invention; and

FIG. 4 shows a block diagram of an apparatus 400 for obtaining channel feedback at a base station in a wireless communication system using coordinated multi-point CoMP joint transmission according to exemplary embodiments of the present invention.

In the drawings, same or corresponding reference numerals represent same or corresponding contents or parts.

### DETAILED DESCRIPTION OF THE PREFERRED EMBODIMENTS

Hereinafter, embodiments of the present invention will be detailed with reference to the accompanying drawings. As described above in summary and hereinafter in detail, according to embodiments of the present invention, in a wireless communication system using CoMP transmission, the channel feedback from the UE to the base station is divided into two stages, wherein in each stage, different types of channel feedback are transmitted. During the first stage, information on long-term feature and/or wideband feature of the channel is fed back; during the second stage, information on short-term feature and/or subband feature of the channel is fed back. The first stage and the second stage may be periodically repeated, and their repeating periods may be either identical or different. The information fed back during the first stage and second stage is collected at the base station, and is used for deriving feedback information characterizing a joint-channel feature. In this way, overheads associated with the channel feedback may be effectively reduced.

It should be noted that in the following description, the terms “stage” and “period of time” may be used interchangeably, both of which refer to a time interval for transmitting information. Specifically, in the context of the present invention, the first stage (the first period of time) and the second stage (the second period of time) for transmitting feedback information may occur periodically, which will be detailed hereinafter.

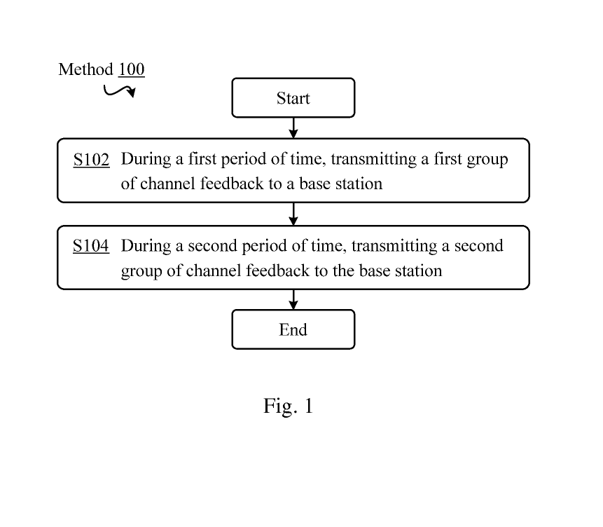

First, referring to FIG. 1, a flowchart of a method 100 of providing channel feedback from a user equipment in a wireless communication system using coordinated multi-point CoMP joint transmission is shown according to exemplary embodiments of the present invention. It should be noted that according to embodiments of the present invention, a wireless communication system using CoMP transmission generally comprises at least one user equipment (UE). The method 100 may be executed at each of these UEs, for example, executed by the UE itself or a component thereof.

After start of the method 100, in step S102, a UE transmits a first group of channel feedback to a base station during a first period of time. According to embodiments of the present invention, the first group of channel feedback may involve long-term channel features of a channel between the UE and the base station, and/or wideband channel features of the channel. In other words, the first group of channel feedback may primarily involve cell-specific channel information.

Specifically, according to some embodiments of the present invention, the channel feedback contained in the first group of channel feedback may involve, for example, channel directions in the same polarization direction of the cell where the UE is located. For example, the long-term channel directions of the same polarization direction from the same cell k are represented by Uₖ. Each UE in the cell K may measure Uₖ, and the Uₖ may be quantized, for example, by a common codebook having a N-point discrete Fourier transform (DFT) vector. As an example, for a 4-transmit (4Tx) antenna, the codebook has a dimension of 2×1. Moreover, the codebook may reuse the 2Tx codebook of the existing LTE-A Rel-20, with a codebook length N being 4. Of course, a DFT vector with a longer length may also be employed to quantize Uₖ, which may generally expressed as follows:

$${v}_{n} = {\frac{1}{\sqrt{2}} [ 1 {e}^{j \frac{2 π n}{N}} ]}^{T} , n = 0 , 1 , … , N - 1 \qquad ( 1 )$$

In this way, during the first period of time, the UE from the cell k may transmit Vn as defined above to the base station to feed back Uₖ.

Alternatively or additionally, according to embodiments of the present invention, during the first period of time, the channel feedback transmitted from the UE to the base station may also involve the power imbalance for geographically separated different antennas from the cell where the UE is located. According to embodiments of the present invention, the power imbalance for different antennas is represented as a which, for example, may be quantized using a codebook vector {0.2, 0.6, 0.8, 0.9}, wherein the codebook size is 2 bits or larger. In fact, the codebook vector may be generally quantized with a {0, 1} range, and may have any number of codebooks. Therefore, during the first period of time, the UE may transmit the power imbalance for different antennas that are geographically separated by feeding such codebook back to the base station.

According to some other embodiments of the present invention, the long-term and/or wideband channel features as transmitted from the UE to the base station during the first period of time may also include eigen-beamforming direction of the cell where the user equipment is located and a power imbalance for different antennas from the cell that are geographically separated.

Specifically, according to these embodiments of the present invention, the long-term eigen-beamforming information of each cell may be quantized using a common codebook having an N-point vector. For example, for a 4Tx antenna, a cell-specific eigen-beamforming direction may be quantized by multiplexing a LTE R10 4Tx codebook, which may better guarantee the adaptability with the existing system. In this case, the codebook dimension is 4×1, with a size of 16.

It should be noted that the long-term and/or wideband channel features that transmitted from the UE to the base station during the first period of time may be measured and quantized using any appropriate technical means, whether currently known or to be developed in the future. Specifically, the codebooks used to quantize the channel measurements as described above are only exemplary. The scope of the present invention is not limited in this regard.

It should be noted that the channel direction information in the same polarization direction, power imbalance for different antennas, and beamforming direction of each cell, as above mentioned, are only examples of the long-term and/or wideband channel features. Any other long-term or wideband channel features may be measured and quantized by the UE and fed back to the base station within the first period of time. The scope of the present invention is not limited in this regard.

Next, the method 100 proceeds to step S104 where the UE transmits a second group of channel feedback of a different type from the first group of channel feedback to the base station during a second period of time. According to embodiments of the present invention, the second group of channel feedback may involve short-term channel features for a channel between the UE and the base bastion, and/or narrowband channel features for the channel. In other words, the second group of channel feedback may mainly involve channel condition related to inter-cell coordination.

Specifically, according to some embodiments of the present invention, channel feedback information included in the second group of channel feedback may involve amplitude adjustment information between different polarization directions. For example, the amplitude adjustment between different polarization directions from the cell k is represented asβₖ. A UE located in the cell k may measure βₖ, and quantize it, for example, by using a 2-bit codebook vector {0.2, 0.6, 0.8, 0.9}. It would be appreciated that βₖ may characterize the amplitude adjustment between different polarization directions from the same cell. However, through a joint selection on the βₖ, it may also reflect and compensate to a certain extent the power imbalance caused on a fast fading channel of different coordinated cells. In other words, according to embodiments of the present invention, the amplitude adjustment feedback transmitted to the base station during the second period of time may not only characterize and further compensate for the amplitude adjustment between different polarization directions from the same cell, but also may consider the amplitude adjustment among different coordinated cells.

Alternatively or additionally, according to embodiments of the present invention, the channel feedback included in the second group of channel feedback may involve phase difference between different polarization directions. For example, the phase difference between different polarization directions is represented as θ. The UE measures the phase differentθ, and for example, a 2-bit codebook vector {0, π/2, π, −π/2} may be used to quantize. It should be noted that, in embodiments of the present invention, although the phase difference is represented as θ and may be a phase different between different polarization directions within the same cell, it can still reflect to a certain extend the phase difference from between different cells or coordinated antennas. Therefore, by feeding back such information, the objective of correcting or compensating the two kinds of phase differences may be realized.

Specifically, in some embodiments of the present invention, a codebook vector may be quantized with the range of {0, 2π} using any feedback bit, which might be advantageous.

It should be noted that the short-term and/or wideband channel features as transmitted from the UE to the base station during the second period of time may be measured and quantized by any existing or possibly evolved suitable technical means in the future. Specifically, the above codebook for quantizing channel measurement is only exemplary, not intended to limit the present invention. Thus, the scope of the present invention is not limited thereto.

It should also be noted that the amplitude adjustment information and phase difference information in the above mentioned different polarization directions are only examples of short-term and/or narrowband channel features. Any other short-term or narrowband channel features may be measured and quantized by the UE and fed back to the base station within the second period of time. The scope of the present invention is not limited thereto.

The method 100 ends after completion of step S104. By performing the method 100 at the UE, it is seen that the channel feedback regarding long-term and/or wideband channel features and the measurement feedback regarding short-term and/or narrowband channel features are transmitted to the base station during different periods of time (stages).

It should be particularly noted that although step S102 is illustrated to be executed prior to step S104 and the method 100 ends after completion of step S104, they are only for illustrative and exemplary purposes. In practice, the UE may periodically perform step S102 and step S104. In other words, the method 100 or steps S102 and S104 may be performed periodically.

Specifically, according to some embodiments of the present invention, the periods for performing steps S102 and S104 may be different. For example, the feedback cycle for the first period of time for transmitting the first type of channel feedback, as above mentioned, may be larger than or equal to the feedback cycle for the second period of time for transmitting the second kind of channel feedback. In other words, transmission of the first group of channel feedback is less frequent than transmission of the second group of channel feedback. Such an embodiment is based on the following consideration, i.e., compared with short-term and/or narrow-band channel features, variation of the long-term and/or wideband channel features is less frequent. Through discriminatively setting the first-stage and the second-stage feedback periods, feedback overheads may be effectively reduced. Of course, the period relationship between the two periods of time is non-limiting.

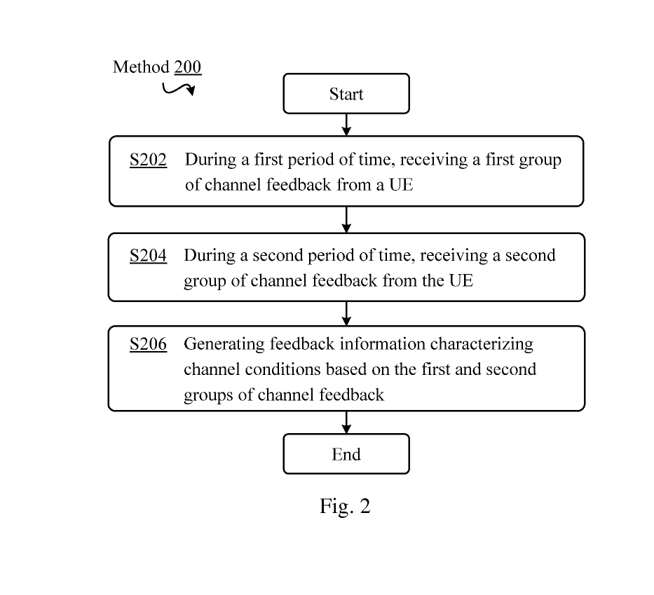

Now referring to FIG. 2, a flowchart of a method 200 of obtaining channel feedback at a base station in a wireless communication system using coordination multi-point CoMP joint transmission is shown according to exemplary embodiments of the present invention. According to embodiments of the present invention, the method 200 may be executed at a base station in the wireless communication system, for example, executed by the base station itself or a component thereof.

After the method 200 starts, in step S202, the base station receives a first group of channel feedback from one or more UEs in the wireless communication system during a first period of time. It would be appreciated that step S202 corresponds to step S102 in method 100. Thus, the above description on the first group of channel feedback as provided in step S102 of method 100 is likewise suitable for step S202. Specifically, according to embodiments of the present invention, the first group of channel feedback may involve long-term channel features and/or wideband channel features for a channel between the UE and the base station, i.e., cell-specific channel features.

As an example, the first group of channel feedback may contain channel feedback involving at least one of: channel direction in the same polarization direction from the cell where the UE is located, and a power imbalance for different antennas that are geographically separated.

Additionally, according to some other embodiments of the present invention, the long-term and/or wideband channel features as transmitted from the UE to the base station during the first period of time may further include: eigen-beamforming direction of the cell where the UE is located, and a power imbalance for different antennas from the cell that are geographically separated.

Next, the method 200 proceeds to step S204, where the base station receives from one or more UEs during a second period of time a second group of channel feedback of a different type from the first group of channel feedback. It should be understood that step S204 corresponds to step S104 in method 100. Therefore, the above description on the first group of channel feedback as provided in step S104 of the method 100 is likewise applicable to step S204. Specifically, according to embodiments of the present invention, the second group of channel feedback may involve short-term channel features and narrowband channel features for a channel between the UE and the base station, i.e., channel features related to inter-cell coordination. As an example, the second group of channel feedback may contain channel feedback information involving at least one of: amplitude adjustment between different polarization directions, and phase difference between different polarization directions.

As mentioned above, according to some embodiments of the present invention, the feedback cycle for the first period of time may be greater than or equal to the feedback cycle for the second period of time. Of course, it is not compulsory.

The method 200 then proceeds to step S206, where the base station generates feedback information characterizing an overall channel condition between the base station and each UE based on the first group of channel feedback and the second group of channel feedback received from the UE.

In order to clearly illustrate the operation of step S206, the following example is considered. Suppose there are 3 coordinated cells in the wireless communication system using CoMP transmission. First, each time when the base station receives a first group of channel feedback from UEs within the three cells during a first period of time, the base station may generate a first type of feedback information characterizing channel conditions in a first aspect (for example, the aspect of long-term and/or wideband features).

For example, when the base station receives from UEs in each cell k (k=1, 2, 3) feedback regarding long-term channel direction information uₖ of the same polarization direction of the cell k and the power imbalances α₁ and α₂ for different antennas that are geologically separated within the cell k, the base station may calculate the first type of feedback information based on the received data. As an example, the first type of feedback information is denoted as W₁, and then the base station may for example obtain W₁ as follows:

$${W}_{1} = [ \begin{matrix}\sqrt{1 - {α}_{1}^{2} - {α}_{2}^{2}} ( \begin{matrix}{u}_{1} & 0 \\ 0 & {u}_{1}\end{matrix} ) & 0 & 0 \\ 0 & {α}_{1} ( \begin{matrix}{u}_{2} & 0 \\ 0 & {u}_{2}\end{matrix} ) & 0 \\ 0 & 0 & {α}_{2} ( \begin{matrix}{u}_{3} & 0 \\ 0 & {u}_{3}\end{matrix} )\end{matrix} ] \qquad ( 2 )$$

Likewise, after the base station receives from the UE in each cell k (k-1, 2, 3) the amplitude adjustment (denoted as βₖ) between different polarization directions from the cell k and the phase difference (denoted as θᵢ, wherein for the scenario of three cells, i=1 . . . 5), the base station may generate a second type of feedback information characterizing channel conditions in a second aspect (for example, aspect of short-term and/or narrowband features) based on the received data. As an example, the second type of feedback information is denoted as W₂, and then the base station may for example calculate W₂ as follows:

$${W}_{2} = [ \begin{matrix}{β}_{1} \\ \sqrt{1 - {β}_{1}^{2}} {e}^{{jθ}_{1}} \\ {β}_{2} {e}^{{jθ}_{2}} \\ \sqrt{1 - {β}_{2}^{2}} {e}^{{jθ}_{3}} \\ {β}_{3} {e}^{{jθ}_{4}} \\ \sqrt{1 - {β}_{3}^{2}} {e}^{{jθ}_{5}}\end{matrix} ] / 3 \qquad ( 3 )$$

Then the base station may further obtain feedback information regarding the overall channel condition between the base station and a plurality of cells based on W₁ and W₂. For example, the overall feedback information is denoted as W, then the base station may for example calculate W as follows:

$$W = {W}_{1} {W}_{2} = [ \begin{matrix}\sqrt{1 - {α}_{1}^{2} - {α}_{2}^{2}} ( \begin{matrix}{u}_{1} & 0 \\ 0 & {u}_{1}\end{matrix} ) & 0 & 0 \\ 0 & {α}_{1} ( \begin{matrix}{u}_{2} & 0 \\ 0 & {u}_{2}\end{matrix} ) & 0 \\ 0 & 0 & {α}_{2} ( \begin{matrix}{u}_{3} & 0 \\ 0 & {u}_{3}\end{matrix} )\end{matrix} ] [ \begin{matrix}{β}_{1} \\ \sqrt{1 - {β}_{1}^{2}} {e}^{{jθ}_{1}} \\ {β}_{2} {e}^{{jθ}_{2}} \\ \sqrt{1 - {β}_{2}^{2}} {e}^{{jθ}_{3}} \\ {β}_{3} {e}^{{jθ}_{4}} \\ \sqrt{1 - {β}_{3}^{2}} {e}^{{jθ}_{5}}\end{matrix} ] / 3 \qquad ( 4 )$$

The W₁ regarding the first type of feedback information, W₂ regarding the second type of feedback information, and W obtained thereby as described above are merely exemplary. According to embodiments of the present invention, the base station may also employ other manners to obtain the feedback information regarding the overall channel condition between the base station and a plurality of cells based on the received different type of UE measurement feedback information. Hereinafter, another exemplary alternative embodiment will be described.

Still considering the scenario of three cells as an example, similar to the above example, each time when the base station receives the first group of channel feedback from the UEs in the three cells, the base station may generate a first type of feedback information characterizing channel conditions in the first aspect (for example, aspect of long-term and/or narrowband features). For example, after the base station receives from UEs of cell k (k=1, 2, 3) measurement feedback (denoted as Vₖ) regarding cell k's eigen-beamforming information and measurement feedback (α₁ and α₂) regarding power imbalance for different antennas within the cell k that are geographically separated, the base station may calculate the first type of feedback information based on the above information. Once again, the first type of feedback information is denoted as W₁. The base station may obtain W₁ for example as follows:

$${W}_{1} = [ \begin{matrix}\sqrt{1 - {α}_{1}^{2} - {α}_{2}^{2}} {V}_{1} \\ {α}_{1} {V}_{2} \\ {α}_{2} {V}_{3}\end{matrix} ] \qquad ( 5 )$$

Likewise, after the base station receives the amplitude adjustment (denoted as βₖ) between different polarization directions of the cell k from the UE within the cell k (k=1, 2, 3) and phase difference (denoted as θᵢ, in the case of three cells, i=1 . . . 5), the base station may generate a second type of feedback information characterizing channel conditions in the second aspect (for example, aspect of short-term and/or narrowband features) based on the received data. Once again, the second type of feedback information is denoted as W₂. The base station may calculate W₂ for example as follows:

$${W}_{2} = [ \begin{matrix}{β}_{1} I & 0 & 0 & 0 & 0 & 0 \\ 0 & \sqrt{1 - {β}_{1}^{2}} {e}^{{jθ}_{1}} I & 0 & 0 & 0 & 0 \\ 0 & 0 & {β}_{2} {e}^{{jθ}_{2}} I & 0 & 0 & 0 \\ 0 & 0 & 0 & \sqrt{1 - {β}_{2}^{2}} {e}^{{jθ}_{3}} I & 0 & 0 \\ 0 & 0 & 0 & 0 & {β}_{3} {e}^{{jθ}_{4}} I & 0 \\ 0 & 0 & 0 & 0 & 0 & \sqrt{1 - {β}_{3}^{2}} {e}^{{jθ}_{5}} I\end{matrix} ] / 3 \qquad ( 6 )$$

wherein I denotes a unit matrix. For 4Tx, matrix I has a dimension of 2×2.

Then the base station may obtain feedback information regarding the overall channel condition between the base station and a plurality of cells based on W₁ and W₂. For example, the overall feedback information is denoted as W, and the base station may calculate W for example as follows:

$$W = {W}_{2} {W}_{1} = [ \begin{matrix}{β}_{1} I & 0 & 0 & 0 & 0 & 0 \\ 0 & \sqrt{1 - {β}_{1}^{2}} {e}^{{jθ}_{1}} I & 0 & 0 & 0 & 0 \\ 0 & 0 & {β}_{2} {e}^{{jθ}_{2}} I & 0 & 0 & 0 \\ 0 & 0 & 0 & \sqrt{1 - {β}_{2}^{2}} {e}^{{jθ}_{3}} I & 0 & 0 \\ 0 & 0 & 0 & 0 & {β}_{3} {e}^{{jθ}_{4}} I & 0 \\ 0 & 0 & 0 & 0 & 0 & \sqrt{1 - {β}_{3}^{2}} {e}^{{jθ}_{5}} I\end{matrix} ] [ \begin{matrix}\sqrt{1 - {α}_{1}^{2} - {α}_{2}^{2}} {V}_{1} \\ {α}_{1} {V}_{2} \\ {α}_{2} {V}_{3}\end{matrix} ] / 3 \qquad ( 7 )$$

From the above two different exemplary embodiments described with reference to equations (2)-(4) and (5)-(7), it is seen that when the measurement feedback information provided by the UE to the base station is different, the base station may adopt different manners to obtain the overall feedback information characterizing the channel conditions from the above measurement feedback information.

It should be noted that the above examples described with reference to three coordinated cells are only for illustrative and descriptive purposes. Based on the teaching provided herein, the principle of the present invention may be readily and directly applicable to the scenario of any number of coordinated cells. Moreover, it should also be noted that the definitions and calculations of W₁, W₂, and W as provided above are merely exemplary. Based on the feedback information received from the UEs in two stages, the base station may calculate W₁, W₂, and/or W in any additional and/or alternative manner based on the specific application scenario and requirement. The scope of the present invention is not limited in those aspects.

Through the above depictions on method 100 and method 200, those skilled in the art would appreciate that according to embodiments of the present invention, a new channel feedback mechanism is proposed between the base station and the UE in a wireless communication system using CoMP transmission. Based on this mechanism, unlike the prior art, the channel feedback is implemented by being divided into two stages, and a different type of channel feedback is transmitted within each stage. For example, during the first stage, feedback information such as cell-specific polarization direction, power imbalance, and beamforming direction of each cell may be transmitted, while during the second stage, amplitude adjustment and phase different information between different polarization directions within the same cell and between different coordinated cells may be transmitted. The feedback information transmitted during the two stages is summed at the base station respectively, and is jointly used for generating the complete feedback information reflecting the overall channel condition.

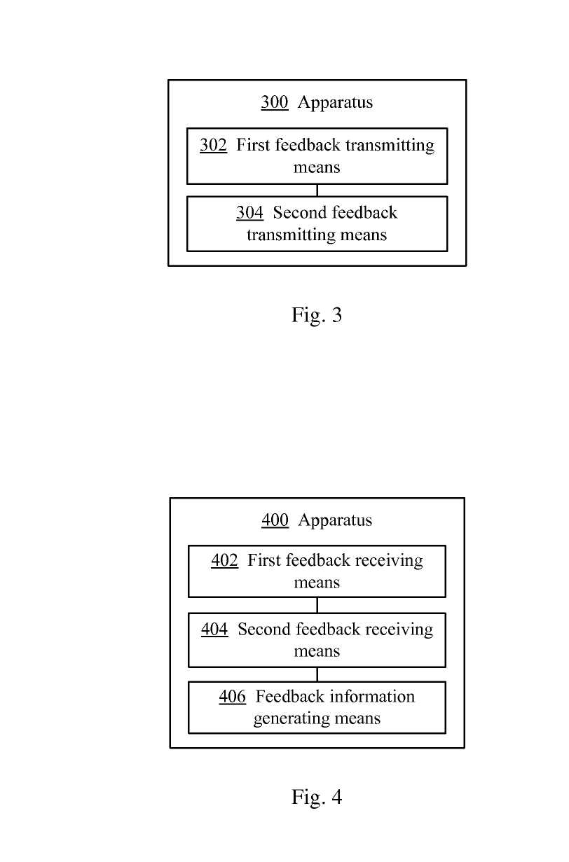

Hereinafter, referring to FIG. 3, it shows a block diagram of an apparatus 300 for providing feedback channel from a user equipment in a wireless communication system using coordinated multi-point (CoMP) joint transmission according to exemplary embodiments of the present invention. According to embodiments of the present invention, the apparatus 300 may reside at one or more user equipment UEs of a wireless communication system or otherwise associated with the UEs. It should be understood that the apparatus 300 is operable to perform the above described method 100.

As illustrated in FIG. 3, according to embodiments of the present invention, the apparatus 300 comprises first feedback transmitting means 302 configured to transmit a first group of channel feedback to a base station in the wireless communication system during a first period of time; and second feedback transmitting means 304 configured to transmit a second group of channel feedback of a different type from the first group of channel feedback to the base station during a second period of time.

According to embodiments of the present invention, the first feedback transmitting means 302 may comprise third feedback transmitting means configured to transmit channel feedback involving at least one of: a long-term channel feature and wideband channel feature for a channel between the user equipment and the base station. Further, the second feedback transmitting means 304 may comprise fourth feedback transmitting means configured to transmit channel feedback involving at least one of: a short-term channel feature and a narrowband channel feature for a channel between the user equipment and the base station.

In such embodiments, the third feedback transmitting means may comprise means configured to transmit channel feedback involving at least one of: a channel direction in a same polarization direction of a cell where the user equipment is located, and a power imbalance for different antennas from the cell that are geographically separated. Alternatively or additionally, the third feedback transmitting means may comprise means configured to transmit channel feedback involving at least one of: a beamforming direction of a cell where the user equipment is located, and a power imbalance for different antennas from the cell that are geographically separated.

The fourth feedback transmitting means comprises means configured to transmit channel feedback involving at least one of: an amplitude adjustment between different polarization directions, and a phase different between different polarization directions.

Specifically, according to some embodiments of the present invention, as mentioned above, the feedback cycle for the first period of time is larger than or equal to the feedback cycle for the second period time.

As mentioned above, the apparatus 300 shown in FIG. 3 may be the entity for performing the above described method 100. Thus, various features as described above with reference to FIG. 1 are all suitable for apparatus 300, which will not be detailed here.

Hereinafter, referring to FIG. 4, it shows a block diagram of an apparatus 400 for obtaining channel feedback at a base station in a wireless communication system using coordinated multi-point (COMP) joint transmission according to exemplary embodiments of the present invention. According to embodiments of the present invention, the apparatus 400 may reside at a base station of a wireless communication system or otherwise associated with the base station. It should be understood that the apparatus 400 is operable to perform the above described method 200.

As illustrated in FIG. 4, according to embodiments of the present invention, the apparatus 400 comprises first feedback receiving means 402 configured to receive a first group of channel feedback from a user equipment in the wireless communication system during a first period of time; second feedback receiving means 402 configured to receive a second group of channel feedback of a different type from the first group of channel feedback from the user equipment during a second period of time; and feedback information generating means 406 configured to generate feedback information characterizing channel conditions between the base station and the user equipment based on the first group of channel feedback and the second group of channel feedback.

According to some embodiments of the present invention, the first feedback receiving means 402 may comprise third feedback receiving means configured to receive channel feedback involving at least one of: a long-term channel feature and a wideband channel feature for a channel between the user equipment and the base station. Moreover, the second feedback receiving means 404 comprises fourth feedback receiving means configured to receive channel feedback involving at least one of: a short-term channel feature and a narrowband channel feature for a channel between the user equipment and the base station.

In such an embodiment, the third feedback receiving means comprises means configured to receive channel feedback involving at least one of: a channel direction in a same polarization direction of the cell where the user equipment is located, and a power imbalance for different antennas from the cell that are geographically separated. Alternatively or additionally, the third feedback transmitting means may comprise means configured to transmit channel feedback involving at least one of: a beamforming direction of the cell where the user equipment is located, and a power imbalance for different antennas from the cell that are geographically separated.

Besides, the fourth feedback transmitting means comprises means configured to transmit channel feedback involving at least one of: amplitude adjustment between different polarization directions, and phase different between different polarization directions.

Specifically, according to some embodiments of the present invention, as mentioned above, the feedback cycle for the first period of time is larger than or equal to the feedback cycle for the second period time.

As above mentioned, the method 400 as shown in FIG. 4 may be the entity for performing the above described method 200. Thus, various features as described above with reference to FIG. 2 are all suitable for apparatus 400, which will not be detailed here.

It should be understood that partitioning of respective means in apparatuses 300 and 400 is not limiting but just exemplary. For example, as above mentioned, functions of a single means may be implemented by a plurality of means. And a plurality of means as above mentioned may also be implemented by a single means. The scope of the present invention is not limited thereto.

It should also be noted that various means as comprised in apparatuses 300 and 400 may be implemented in various manners including software, hardware, firmware, or any combination thereof. For example, in some embodiments, respective means of apparatuses 300 and 400 may be implemented by software and/or firmware modules. Alternatively or additionally, various means of apparatuses 300 and 400 may also be implemented with hardware modules. For example, various means of apparatuses 300 and 400 may be implemented as an integrated circuit (IC) chip or an application specific indicated circuit (ASIC). Various means of apparatuses 300 and 400 may also be implemented as a system on chip (SOC). Other existing or future evolved manners are also applicable, and the scope of the present invention is not limited thereto.

The principle and spirit of the present invention have been illustrated above with reference to several exemplary embodiments. Experiments show that through the methods and apparatuses according to embodiments of the present invention, feedback overheads of a CoMP-based wireless communication system may be effectively reduced. For example, Table 1 below shows feedback overheads of a concatenated codebook in the prior art; Table 2 shows feedback overheads of a two-stage CoMP feedback mechanism according to embodiments of the present invention. Through the comparison in Table 3, it is seen that (with 3 coordinated cells as an example), the two-stage CoMP feedback mechanism as proposed in the present invention reduces the uplink channel feedback overheads by 58%.

TABLE 1
Feedback Overheads of A Concatenated Codebook in the Prior Art

| | Feedback bit (2-PRB, non-CM 8-bit codebook, |
|---|---|
| Feedback items | M cells coordination) |
| Cell-specific PMI (5 subframes) | 8 × M × 25 bits/5 |
| Phase adjustment (5 subframes) | 5 × (M − 1) × 25 bits/5 |
| Amplitude adjustment (5 subframes) | 5 × (M − 1) × 25 bits/5 |
| CQI (5 subframes) | 4 × 25 bits/5 |
| Total overheads | (8 × M × 25 + 5 × (M − 1) × 25 + 5 × (M − 1) × 25 + |
| | 4 × 25)/5 = 90 × M − 30 |

TABLE 2
Feedback Overheads according to Embodiments of the Present Invention

| | Feedback bit |
|---|---|
| | (2-PRB, 2Tx4-bit DFT codebook, M cells |
| Feedback items | coordination |
| Cell-specific polarization direction | 4xM bits/100 |
| (100 subframes, wideband) | |
| Power imbalance (100 subframes, wideband) | 5 × (M − 1) bits/100 |
| Phase adjustment | 2 × (2M − 1) × 25 bits /5 |
| Amplitude adjustment (5 subframes) | 2 × M × 25 bits/5 |
| CQI (5 subframes) | 4 × 25 bits/5 |
| Total overheads | (4 × M + 5 × (M − 1))/100 + (2 × (2M − 1) × |
| | 25 + 2 × M × 25 + 4 × 25)/5 = 30.09 × M + 9.95 |

TABLE 3
Comparison between Feedback Overheads (M = 3)

| | Feedback overheads (bits of |
|---|---|
| Feedback strategy | each subframe of each UE |
| Current concatenated codebook | 240 |
| Two-stage CoMP codebook strategy | 100.22 |
| of the present invention | |
| Overall reduction | 58% |

It should be noted that the flowcharts and block diagrams in the figures illustrate the system architecture, functions and operations potentially implemented by the method, system and apparatus according to various embodiments of the present invention. In this regard, each block in the flowcharts or block diagrams may represent a module, a program segment, or a part of code, which contains one or more executable instructions for performing specified logic functions. It should also be noted that, in some alternative implementations, the functions noted in the blocks may also occur in a sequence different from what is noted in the drawings. For example, two blocks shown consecutively may be performed in parallel substantially or in an inverse order.

It should also be noted that each block in the block diagrams and/or flowcharts and a combination of blocks in block diagrams and/or flow charts may be implemented by a dedicated hardware-based system for executing a prescribed function or operation or may be implemented by a combination of dedicated hardware and computer instructions. It should be understood that the figures and embodiments of the present invention are merely for exemplary purposes, not intended for limiting the protection scope of the present invention.

The method according to the present invention may be implemented in software, hardware, or a combination of software and hardware. The hardware part may be implemented with a dedicated logic; the software part may be stored in a memory and executed by an appropriate instruction execution system, for example a microprocessor, a personal computer or a mainframe. In a preferred embodiment, the present invention is implemented as software, including, without limitation to, firmware, resident software, micro-code, etc.

Moreover, the present invention may be implemented as a computer program product usable from computers or accessible by computer-readable media that provide program code for use by or in connection with a computer or any instruction executing system. For the purpose of description, a computer-usable or computer-readable medium may be any tangible means that can contain, store, communicate, propagate, or transport the program for use by or in connection with an instruction execution system, apparatus, or device.

The medium may be an electric, magnetic, optical, electromagnetic, infrared, or semiconductor system (apparatus or device), or propagation medium. Examples of the computer-readable medium would include the following: a semiconductor or solid storage device, a magnetic tape, a portable computer diskette, a random access memory (RAM), a read-only memory (ROM), a hard disk, and an optical disk. Examples of the current optical disk include a compact disk read-only memory (CD-ROM), compact disk-read/write (CR-ROM), and DVD.

A data processing system adapted for storing or executing program code according to embodiments of the present invention would include at least one processor that is coupled to a memory element directly or via a system bus. The memory element may include a local memory usable during actually executing the program code, a mass memory, and a cache that provides temporary storage for at least one portion of program code so as to decrease the number of times for retrieving code from the mass memory during execution.

An Input/Output or I/O device (including, without limitation to, a keyboard, a display, a pointing device, etc.) may be coupled to the system directly or via an intermediate I/O controller.

A network adapter may also be coupled to the system such that the system can be coupled to other processing systems, remote printers or storage devices via an intermediate private or public network. A modem, a cable modem, and an Ethernet card are merely examples of a currently usable network adapter.

It should be noted that in order to make embodiments of the present invention more comprehensible, the above description omits some more specific technical details which are known to the skilled in the art and may be essential to implement the present invention. The purpose for providing the description of the present invention is to explain and describe, not to exhaust or limit the present invention within the disclosed form. To a person of normal skill in the art, various modifications and alternations are obvious.

Although a plurality of embodiments of the present invention have been described above, those skilled in the art should understand that these depictions are only exemplary and illustrative. Based on the teachings and inspirations from the specification, modifications and alterations may be made to the respective embodiments of the present invention without departing from the true spirit of the present invention. Thus, the features in the specification should not be regarded as limitative. The scope of the present invention is only limited by the appended claims

1. A method of providing channel feedback from a user equipment in a wireless communication system using coordinated multi-point joint transmission, the method comprising:
during a first period of time, transmitting a first group of channel feedback to a base station in the wireless communication system; and
during a second period of time, transmitting to the base station a second group of channel feedback of a different type from the first group of channel feedback.

2. The method according to claim 1, wherein
the first group of channel feedback involves at least one of a long-term channel feature and a wideband channel feature of a channel between the user equipment and the base station; and
the second group of channel feedback involves at least one of a short-term channel feature and a narrowband channel feature of a channel between the user equipment and the base station.

3. The method according to claim 2, wherein the first group of channel feedback comprises channel feedback involving at least one of: a channel direction in a same polarization direction from a cell where the user equipment is located, and a power imbalance for different antennas from the cell that are geographically separated.

4. The method according to claim 2, wherein the first group of channel feedback comprises channel feedback involving at least one of: a beamforming direction of a cell where the user equipment is located, and a power imbalance for different antennas from the cell that are geographically separated.

5. The method according to claim 2, wherein the second group of channel feedback comprises channel feedback involving at least one of: an amplitude adjustment between different polarization directions, and a phase difference between different polarization directions.

6. The method according to claim 1, wherein a feedback cycle for the first period of time is greater than or equal to a feedback cycle for the second period of time.

7. A method of obtaining channel feedback at a base station in a wireless communication system using coordinated multi-point joint transmission, the method comprising:
during a first period of time, receiving a first group of channel feedback from a user equipment in the wireless communication system;
during a second period of time, receiving from the user equipment a second group of channel feedback of a different type from the first group of channel feedback; and
generating feedback information characterizing channel conditions between the base station and the user equipment based on the first group of channel feedback and the second group of channel feedback.

8. The method according to claim 7, wherein
the first group of channel feedback involves at least one of a long-term channel feature and a wideband channel feature of a channel between the user equipment and the base station; and
the second group of channel feedback involves at least one of a short-term channel feature and a narrowband channel feature of a channel between the user equipment and the base station.

9. The method according to claim 8, wherein the first group of channel feedback comprises channel feedback involving at least one of: a channel direction in a same polarization direction from a cell where the user equipment is located, and a power imbalance for different antennas from the cell that are geographically separated.

10. The method according to claim 8, wherein the first group of channel feedback comprises channel feedback involving at least one of: a beamforming direction of a cell where the user equipment is located, and a power imbalance for different antennas from the cell that are geographically separated.

11. The method according to claim 8, wherein the second group of channel feedback comprises channel feedback involving at least one of: an amplitude adjustment between different polarization directions, and a phase difference between different polarization directions.

12. (canceled)

13. An apparatus for providing channel feedback from a user equipment in a wireless communication system using coordinated multi-point joint transmission, the apparatus comprising:
first feedback transmitting means configured to transmit a first group of channel feedback to a base station in the wireless communication system during a first period of time; and
second feedback transmitting means configured to transmit a second group of channel feedback of a different type from the first group of channel feedback to the base station during a second period of time.

14. The apparatus according to claim 13, wherein
the first feedback transmitting means comprises third feedback transmitting means configured to transmit channel feedback involving at least one of: a long-term channel feature and a wideband channel feature of a channel between the user equipment and the base station; and
the second feedback transmitting means comprises fourth feedback transmitting means configured to transmit channel feedback involving at least one of: a short-term channel feature and a narrowband channel feature of a channel between the user equipment and the base station.

15. -18. (canceled)

19. An apparatus for obtaining channel feedback at a base station in a wireless communication system using coordinated multi-point joint transmission, the apparatus comprising:
first feedback receiving means configured to receive a first group of channel feedback from a user equipment in the wireless communication system during a first period of time;
second feedback receiving means configured to receive a second group of channel feedback of a different type from the first group of channel feedback from the user equipment during a second period of time; and
feedback information generating means configured to generate feedback information characterizing channel conditions between the base station and the user equipment based on the first group of channel feedback and the second group of channel feedback.

20. The apparatus according to claim 19, wherein
the first feedback transmitting means comprises third feedback receiving means configured to receive channel feedback involving at least one of: a long-term channel feature and a wideband channel feature of a channel between the user equipment and the base station; and
the second feedback transmitting means comprises fourth feedback receiving means configured to receive channel feedback involving at least one of: a short-term channel feature and a narrowband channel feature of a channel between the user equipment and the base station.

21. -24. (canceled)
